(19) United States
(12) Patent Application Publication
(10) Pub. No.: US 2001/0006225 A1
(43) Pub. Date: Jul. 5, 2001

(54) Slurry for chemical mechanical polishing

(76) Inventors: Yasuaki Tsuchiya, Tokyo (JP); Tomoko Wake, Tokyo (JP); Tetsuyuki Itakura, Tokyo (JP); Shin Sakurai, Tokyo (JP); Kenichi Aoyagi, Tokyo (JP)

Correspondence Address: Paul J. Esatto, Jr., Scully, Scott, Murphy & Presser, 400 Garden City Plaza, Garden City, NY, 11530, US

(21) Appl. No.: 09/745,102

(22) Filed: Dec. 22, 2000

(30) Foreign Application Priority Data
Dec. 28, 1999 (JP) 374484/1999

(51) Int. Cl. C09K 5/00

(52) U.S. Cl. 252/79

(57) ABSTRACT

The present invention relates to a slurry used for chemical mechanical polishing of a substrate having a copper-containing film at the surface, which slurry contains an abrasive, an oxidizing agent, and an adhesion-inhibitor preventing adhesion of a polishing product to a polishing pad. With the polishing slurry of the present invention, even when the copper-containing metal film to be polished has a large thickness or a large area and therefore the amount of the copper-containing metal to be polished is large, adhesion of polishing product to a polishing pad is suppressed and CMP can be completed satisfactorily in a single polishing operation without discontinuation.

### BACKGROUND OF THE INVENTION

1. Field of the Invention

The present invention relates to a slurry for chemical mechanical polishing, used in production of a semiconductor device. More particularly, the present invention relates to a slurry for chemical mechanical polishing, suitably used in formation of buried copper interconnects (damascene copper interconnects).

2. Description of the Related Art

With regard to forming a semiconductor integrated circuit such as ULSI which has been significantly refined and compacted, copper has been expected to be a useful material for electric connection because of its good electromigration resistance and lower electrical resistance.

To date a copper interconnect is formed as follows due to problems such as difficulty in patterning by dry etching. Specifically, a concave such as a groove and a connection hole is formed in an insulating film, a barrier metal film is formed on the surface, a copper film is deposited over the surface by plating such that the concave is filled with the material, and then the surface is polished to be flat by chemical mechanical polishing (hereinafter, referred to as “CMP”) until the surface of the insulating film except the concave area is completely exposed, to form electric connections such as a damascene interconnect in which the concave is filled with copper, a via plug and a contact plug.

There will be described a process for forming a damascene copper interconnect with reference to FIG. 1.

As shown in FIG. 1(a), on a first interlayer insulating film 1 in which a lower-layer interconnect 2 is formed are sequentially formed a silicon nitride film 3 and a second interlayer insulating film 4. Then in the second interlayer insulating film 4 is formed a concave having an interconnect pattern, in a part of which is formed a connecting hole reaching the lower-layer interconnect 2.

Then, as shown in FIG. 1(b), a barrier metal film 5 is formed by sputtering. On the whole surface of the film is formed a copper film 6 by plating such that the concave is filled with the material. The thickness of the plating is larger than the sum of the depth of the groove, the depth of the connecting hole and a manufacturing dispersion in the plating step.

As shown in FIG. 1(c), the copper film 6 is polished by CMP using a polishing pad in the presence of a polishing slurry to make the substrate surface flat. Polishing is continued until the metal over the second insulating film 4 is completely removed, as shown in FIG. 1(d).

A slurry for CMP for polishing copper generally comprises an oxidizing agent and polishing grains. A basic mechanism is that the copper surface is etched by chemical action of the oxidizing agent while the oxidized surface layer is mechanically removed by polishing grains.

As a semiconductor device has been more refined and more integrated, leading to a more complicated device structure, and as there has been increased the layer number of a multilayer aiming at reduction in an interconnect length for dealing with increase in an interconnect resistance associated with refinement of an interconnect or a multilayer in a logic system, a substrate surface has been more bumpy and its level difference has been larger. An upper interconnect in a multilayer interconnect is used for a source interconnect, a signal interconnect or a clock interconnect, and therefore, an interconnect groove must be deeper for improving some properties by reducing resistances in these interconnects. As a result, an interlayer insulating film formed on such a substrate surface has become thicker and thus it has been necessary to form a thick copper film by which a deep concave can be filled, for forming a damascene conductive part such as a damascene copper interconnect or via plug in a thick interlayer insulating film. For reducing a resistance of a refined interconnect or reducing a resistance of a signal or clock interconnect to improve a conduction speed, it is necessary to form an interconnect which is thick in a depth direction, so that a thick copper film is formed for providing a deep concave. When a source interconnect is formed with a damascene copper interconnect, a thick copper film is formed for reducing a resistance of the source interconnect for minimizing a potential change. While conventionally a copper film with a thickness of about several hundred nm has been adequately useful, several thousand nm may be sometimes required for a copper film.

When forming a damascene conductive part by forming such a thick copper film, the amount of copper to be removed by polishing during one CMP step increases, so that a large amount of polishing scrape such as copper or copper oxide adheres to and is accumulated on the surface of a polishing pad. As a result, a polishing rate may become too low to continue polishing or a polished surface cannot be uniform. It is now needed to make a wafer larger for improving a productivity. However, as a wafer becomes larger, an area of a copper film increases, and therefore the amount of copper to be removed by polishing has been increasing. A polishing scrapes such as copper or copper oxide generated during polishing a copper metal film is herein designated a “polishing product”.

A surface plate in a CMP apparatus cannot be so large in the light of factors such as ensuring in-plane uniformity of the surface plate, even diffusivity of a dropped polishing slurry, limitation in an area where the CMP apparatus is placed, workability in replacing a polishing pad and ensuring cleanliness in a clean room.

Increase of the amount of polished copper reduces a throughput at the same polishing rate as that for a thinner film. It is, therefore, necessary to increase a polishing rate for copper. Increase of a polishing rate for copper, however, leads to a large amount of polishing product in a short time, so that adhesion of copper to the surface of the polishing pad becomes more significant.

When a large amount of polishing product adheres to the surface of the polishing pad as described above, the polishing pad must be washed or replaced after every polishing, and furthermore, polishing must be repeated after washing or replacing the polishing pad, resulting in significant reduction in a throughput.

JP-A 10-116804 has demonstrated the problem that copper ions generated during CMP are accumulated on a polishing pad and again adhere to a wafer surface to deteriorate uniformity of the wafer surface and cause electric short-circuit, and has described that the problem can be solved by using a polishing composition comprising a re-adhesion inhibitor such as benzotriazole in CMP. The publication has mentioned the problem due to re-adhesion of copper ions on the wafer surface, but there are no descriptions for the above due to adhesion of a polishing product to a pad surface. Benzotriazole used as a re-adhesion inhibitor may act as an antioxidant (J. B. Cotton, Proc. 2nd Intern. Congr. Metallic Corrosion, (1963) p.590; D. Chadwick et al., Corrosion Sci., 18, (1978) p.39; T. Notodani, Bousei Kanri, 26(3) (1982), p.74; H. Okabe ed., “Sekiyu Seihin Tenkazai no Kaihatsu to Saishin Gijutsu” (1998), CMC, p.77-82), there is a limitation to the amount of the agent for reducing a polishing rate for copper. Furthermore, benzotriazole is originally added for preventing dishing (JP-As 8-83780 and 11-238709). When prevention of dishing is given priority, the amount of the agent is limited.

JP-A 10-46140 has described a polishing composition comprising a particular carboxylic acid, an oxidizing agent and water whose pH is adjusted by an alkali to 5 to 9. Examples in the publication have disclosed a polishing composition containing citric acid as a carboxylic acid and aluminum oxide as a polishing material (Example 7). However, this publication has described only improvement in a polishing rate and prevention of occurring dishing associated with a corrosion mark as an effect of addition of a carboxylic acid such as citric acid.

JP-A 11-21546 has disclosed a polishing process using a slurry for chemical mechanical polishing comprising urea, a polishing material, an oxidizing agent, a film-forming agent and a complex-forming agent. Examples in this publication have described alumina as a polishing material, hydrogen peroxide as an oxidizing agent, benzotriazole as a film-forming agent and citric acid as a complex-forming agent. The publication, however, has described only that addition of the complex-forming agent is effective for disturbing a passive layer formed by a film-forming agent such as benzotriazole and for limiting a depth of an oxidizing layer.

### SUMMARY OF THE INVENTION

An object of the present invention is to provide a slurry for chemical mechanical polishing, which, even in polishing of a large amount of a copper-containing metal, can prevent adhesion of polishing product to a polishing pad and enables CMP satisfactorily in a single polishing operation without discontinuation.

The present invention relates to a slurry used for chemical mechanical polishing of a substrate having a copper-containing film at the surface, which slurry contains an abrasive, an oxidizing agent, and an adhesion-inhibitor preventing adhesion of a polishing product to a polishing pad.

With the polishing slurry of the present invention, even when the copper-containing metal film to be polished has a large thickness or a large area and therefore the amount of the copper-containing metal to be polished is large, adhesion of a polishing product to a polishing pad is suppressed and CMP can be completed satisfactorily in a single polishing operation without discontinuation.

### BRIEF DESCRIPTION OF THE DRAWING

FIG. 1 is a process cross section illustrating a process for forming a damascene copper interconnect.

### DETAILED DESCRIPTION OF THE PREFERRED EMBODIMENTS

Preferred embodiments of the present invention are described below.

With the chemical mechanical polishing slurry of the present invention (hereinafter referred to as “polishing slurry” in some cases) containing citric acid as an agent for prevention of adhesion of polishing product to a polishing pad (the agent is hereinafter referred to as “adhesion-inhibitor”), even when a copper-containing metal film of large thickness or large area is polished, that is, a large amount of a copper-containing metal is polished in a single polishing operation, adhesion of a polishing product to polishing pad can be suppressed and polishing can be conducted satisfactorily without discontinuation. Incidentally, in the present specification, “copper-containing metal” refers to copper or a copper alloy containing copper as the main component.

In a chemical mechanical polishing slurry, a carboxylic acid, an organic acid, has been used as a proton donor for improving a polishing rate, and citric acid has been known only as a kind of such a carboxylic acid. We have conducted intense investigation for solving the above problems and have found that adhesion of a polishing product to a polishing pad may be prevented by adding citric acid in a polishing slurry, to achieve this invention.

The polishing slurry of the present invention can be suitably used in CMP of a substrate having a copper type metal at the surface, without causing staining of polishing pad even when the polishing amount in single polishing operation per unit are of polishing pad is 2×10⁻⁴ g/cm² or more, further 1×10⁻¹ g/cm² or more, furthermore 1×10⁻² g/cm² or more. The polishing slurry of the present invention is also suitably used in CMP using an ordinary polishing pad made of a porous urethane resin or the like.

The polishing slurry of the present invention contains an abrasive, an oxidizing agent, citric acid as an adhesion-inhibitor, and water. The slurry may further contain an antioxidant for prevention of dishing or control of polishing rate.

The content of citric acid in the polishing slurry of the present invention is preferably 0.01 wt % or more, more preferably 0.05 wt % or more to the total amount of the slurry composition, for achieving adequate adhesion-inhibiting effect. When the content of citric acid is too low, adhesion of polishing product to polishing pad takes place easily. The content is preferably 5 wt % or less, more preferably 3 wt % or less from the standpoint of, for example, the thixotropy of polishing slurry.

As the abrasive, there can be used alumina (e.g. α-alumina or θ-alumina), silica (e.g. fumed silica or colloidal silica), titanina, zirconia, germania, ceria, and mixtures of two or more kinds selected from the group consisting of the above metal oxide abrasives. Of these, silica grains and alumina grains are preferred.

An average particle size (diameter) of an abrasive is preferably at least 5 nm, more preferably at least 50 nm, and also preferably 500 nm or less, more preferably 300 nm or less as determined by a light scattering diffraction technique, in the light of a polishing rate, dispersion stability and surface roughness of a polished surface. A particle size distribution is preferably 3 μ m or less, more preferably 1 μm or less for the maximum particle size (d100).

The content of an abrasive in a polishing slurry may be appropriately selected within the range of 0.1 to 50 wt % to the total amount of the slurry composition in the light of factors such as a polishing efficiency and polishing accuracy. It is preferably at least 1 wt %, more preferably at least 2 wt %, further preferably at least 3 wt %, and as its upper limit it is preferably 30 wt % or less, more preferably 10 wt % or less, further preferably 8 wt % or less.

In the light of a polishing rate and corrosion, a slurry viscosity and dispersion stability of an abrasive, a polishing slurry used in this invention has a pH of preferably at least 4, more preferably at least 5 and preferably 8 or less, more preferably 7 or less. Too high pH may cause dissociation of citric acid which leads to reduction in its complex-forming capacity with a polishing product and its adhesion-inhibiting effect, so that the polishing product tends to adhere to a polishing pad. On the other hand, too low pH may excessively increase a polishing rate for copper, leading to deterioration in a surface shape of a copper interconnect, i.e., a recession, which may often cause a step.

For the polishing slurry, pH may be adjusted by a known technique. For example, an alkali may be directly added to a slurry in which polishing grains are dispersed and a carboxylic acid is dissolved. Alternatively, a part or all of an alkali to be added may be added as a carboxylic acid alkali salt. Examples of an alkali which may be used include alkali metal hydroxides such as sodium hydroxide and potassium hydroxide; alkali metal carbonates such as sodium carbonate and potassium carbonate; ammonia; and amines.

The oxidizing agent may be appropriately selected from known water-soluble oxidizing agents in the light of a type of a conductive metal film, polishing accuracy and a polishing efficiency. For example, those which may not cause heavy-metal ion contamination include peroxides such as H₂O₂, Na₂O₂, Ba₂O₂ and (C₆H₅C)₂O₂; hypochlorous acid (HClO); perchloric acid; nitric acid; ozone water; and organic acid peroxides such as peracetic acid and nitrobenzene. Among these, hydrogen peroxide (H₂O₂) is preferable because it does not contain a metal component and does not generate a harmful byproduct. The content of the oxidizing agent in the polishing slurry of this invention is preferably at least 0.01 wt %, more preferably at least 0.05 wt %, further preferably at least 0.1 wt % for achieving adequate effects of its addition while it is preferably 15 wt % or less, more preferably 10 wt % or less for preventing dishing and adjusting a polishing rate to a proper value. When using an oxidizing agent which is relatively susceptible to deterioration with age such as hydrogen peroxide, it may be possible to separately prepare a solution containing an oxidizing agent at a given concentration and a composition which provides a given polishing slurry after addition of the solution containing an oxidizing agent, which are then combined just before use.

A known carboxylic acid or amino acid may be added as a proton donor for enhancing oxidization by the oxidizing agent and achieving stable polishing. Although citric acid which is a carboxylic acid may act as such a proton donor, a different organic acid such as a carboxylic acid and an amino acid may be added.

Carboxylic acids other than citric acid include formic acid, acetic acid, propionic acid, butyric acid, valeric acid, acrylic acid, lactic acid, succinic acid, nicotinic acid, oxalic acid, malonic acid, tartaric acid, malic acid, glutaric acid, citric acid, maleic acid and their salts.

An amino acid may be added as such, as a salt or as a hydrate. Examples of those which may be added include arginine, arginine hydrochloride, arginine picrate, arginine flavianate, lysine, lysine hydrochloride, lysine dihydrochloride, lysine picrate, histidine, histidine hydrochloride, histidine dihydrochloride, glutamic acid, glutamic acid hydrochloride, sodium glutaminate monohydrate, glutamine, glutathione, glycylglycine, alanine, β-alanine, γ-aminobutyric acid, ε-aminocarproic acid, aspartic acid, aspartic acid monohydrate, potassium aspartate, potassium aspartate trihydrate, tryptophan, threonine, glycine, cystine, cysteine, cysteine hydrochloride monohydrate, oxyproline, isoleucine, leucine, methionine, ornithine hydrochloride, phenylalanine, phenylglycine, proline, serine, tyrosine, valine, and a mixture of these amino acids.

The content of the organic acid is preferably at least 0.01 wt %, more preferably at least 0.05 wt % to the total amount of the polishing slurry for achieving adequate effects of its addition, while it is preferably 5 wt % or less, more preferably 3 wt % or less as a content including citric acid for preventing dishing and adjusting a polishing rate to a proper value.

An antioxidant may be further added to a polishing slurry in this invention. Addition of an antioxidant may allow a polishing rate for a copper-containing metal film to be easily adjusted and may result in forming a coating film over the surface of the copper-containing metal film to prevent deterioration in the surface shape of the copper-containing interconnect due to chemical polishing, i.e., dishing and recession.

Examples of an antioxidant include benzotriazole, 1,2,4-triazole, benzofuroxan, 2,1,3-benzothiazole, o-phenylenediamine, m-phenylenediamine, cathechol, o-aminophenol, 2-mercaptobenzothiazole, 2-mercaptobenzimidazole, 2-mercaptobenzoxazole, melamine, and their derivatives. Among these, benzotriazole and its derivatives are preferable. Examples of a benzotriazole derivative include substituted benzotriazoles having a benzene ring substituted with hydroxy; alkoxy such as methoxy and ethoxy; amino; nitro; alkyl such as methyl, ethyl and butyl; halogen such as fluorine, chlorine, bromine and iodine. Furthermore, naphthalenetriazole and naphthalenebistriazole as well as substituted naphthalenetriazoles and substituted naphthalenebistriazoles substituted as described above may be used.

The content of the antioxidant is preferably at least 0.0001 wt %, more preferably at least 0.001 wt % to the total amount of the polishing slurry for achieving adequate effects of its addition, while it is preferably 5.0 wt % or less, more preferably 2.5 wt % or less for adjusting a polishing rate to a proper value. An excessive amount of antioxidant may be excessively anti-corrosive and thus a polishing rate for copper-containing metal may be excessively reduced, leading to a longer CMP time.

A polishing slurry of this invention may contain a variety of additives such as dispersing agents, buffers and viscosity modifiers commonly added to a polishing slurry as long as it does not deteriorate the properties of the slurry.

A composition of the polishing slurry of this invention is preferably adjusted such that a polishing rate for a copper-containing metal film becomes preferably at least 300 nm/min, more preferably at least 400 nm/min. Furthermore, a composition of the polishing slurry of this invention is preferably adjusted such that a polishing rate for a copper metal film becomes preferably 1500 nm/min or less, more preferably 1000 nm/min or less.

A polishing slurry of this invention may be prepared by a common process for preparing a free grain polishing slurry. Specifically, polishing grain particles are added to a dispersion medium to an appropriate amount. A protective agent may be, if necessary, added to an appropriate amount. In such a state, air is strongly adsorbed in the surface of the grain particles, so that the grains are aggregated due to poor wettability. Thus, the aggregated polishing material particles are dispersed into primary particles. In a dispersion process, a dispersion technique and a dispersion apparatus commonly used may be employed. Specifically, dispersion may be conducted using an apparatus such as an ultrasonic disperser, a variety of bead mill dispersers, a kneader and a ball mill by a known process. Citric acid may cause flocculation of polishing grains while enhancing thixotropy. It is, therefore, preferable to add and mix the component after dispersion for achieving good dispersion.

CMP using the polishing slurry of the present invention can be conducted, for example, as follows. A wafer in which, for example, an insulating film and a copper-containing metal film are deposited on a substrate is placed on a spindle wafer carrier. The surface of the wafer is contacted with a polishing pad adhered on a rotary plate (surface plate). While supplying a polishing slurry to the surface of the polishing pad from a polishing slurry inlet, both the wafer and the polishing pad are rotated to polish the wafer. If necessary, a pad conditioner is contacted with the surface of the polishing pad to condition the surface of the polishing pad. The polishing slurry may be fed to the surface of the polishing pad from the side of the rotary plate.

The polishing slurry of this invention described above may be suitably applied to a process for forming an electric connection part such as a damascene interconnect, a via plug and a contact plug by CMP of a substrate where a barrier metal film is formed on an insulating film having a concave such as a groove and a connection hole and a copper metal film is formed over the whole surface such that the concave is filled with the metal, until the surface of the insulating film is substantially completely exposed. Examples of a barrier metal include Ta, TaN, Ti, and TiN. Examples of an insulating film include a silicon oxide film, a BPSG film and an SOG film. Examples of a copper-containing metal film include a copper film as well as a copper alloy film containing copper as the main component, comprising a metal selected from a variety of conductive metals such as silver, gold, platinum, titanium, tungsten, aluminum.

With the polishing slurry of the present invention, even when a large amount of copper-containing metal must be removed by polishing because of a thick or large copper-containing metal film, adhesion of a polishing product to polishing pad can be suppressed. A large amount of copper-containing metal may be, therefore, satisfactorily subject to CMP in one polishing step without discontinuing polishing operation.

Since the waste solution after CMP using the polishing slurry of the present invention has a bluish green color, it is presumed that the copper which has been ionized and solubilized by the action of the oxidizing agent, forms a complex with the citric acid present in the polishing slurry and is discharged in the form of the complex without adhering to the polishing pad or the polished surface.

With the polishing slurry of the present invention, adhesion of polishing product not only to polishing pad surface but also to polished surface can be suppressed; therefore, there occur no problem such as short-circuiting or the like and a polished surface of excellent flatness can be obtained.

### EXAMPLES

This invention will be more specifically described with reference to examples.

CMP conditions

CMP was conducted using a Speedfam-Ipec Type SH-24 apparatus. The polisher was used, on whose surface plate a polishing pad (Rodel-Nitta IC 1400) with a diameter of 61 cm (24 inch) was attached. Polishing conditions were as follows: a contact pressure of the polishing pad: 27.6 kPa (4 psi); a polishing area of the polishing pad: 1820 cm²; a rotating speed of the surface plate: 55 rpm; a carrier rotating speed: 55 rpm; and a polishing slurry feeding rate: 100 mL/min.

Determination of a polishing rate

A polishing rate was calculated from surface resistivities before and after processing. Specifically, four needle electrodes were aligned on a wafer with a given interval. A given current was applied between the outer two probes to detect a potential difference between two inner probes for determining a resistance (R′) and further the value is multiplied by a correction factor RCF (Resistivity Correction Factor) to a surface resistivity (σs′). A surface resistivity (σs) is determined for a wafer film whose thickness (T) (nm) is known. The surface resistivity is inversely proportional to the thickness. Thus, when a thickness for a surface resistivity of σ′s is d, an equation d(nm)= (σs×T)/σ s′ holds true. Using the equation, the thickness d can be determined. Furthermore, a variation between before and after polishing was divided by a polishing time to estimate a polishing rate. A surface resistivity was determined using Mitsubishi Chemical Industries Four Probe Resistance Detector (Loresta-GP).

### Example 1

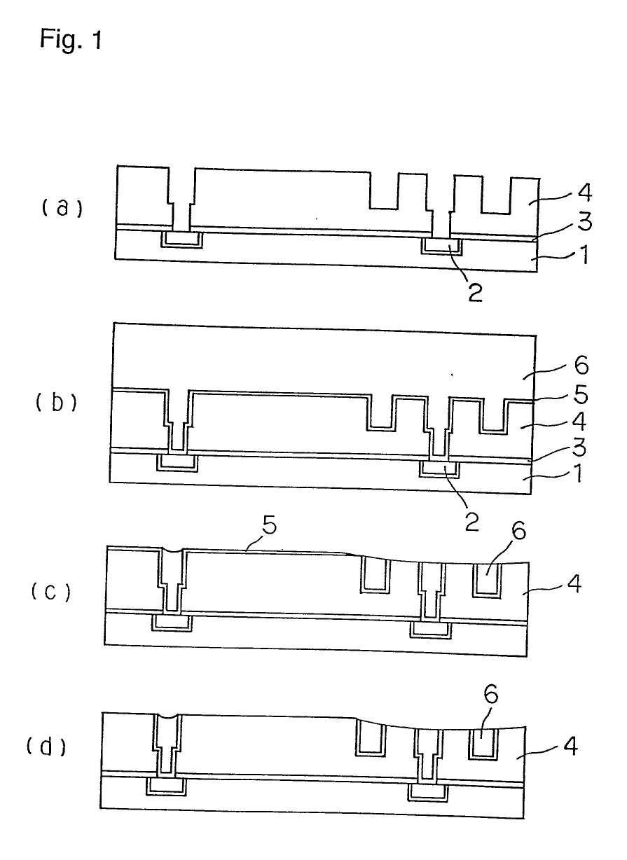

As shown in FIG. 1(a), on a 6 inch wafer (silicon substrate, not shown) in which a semiconductor device such as a transistor was formed was deposited a first silicon oxide film 1 comprising a lower interconnect 2 (not shown). On the film 1 were formed a silicon nitride film 3 and a second silicon oxide film 4 with a thickness of about 1.5 μm. The second silicon oxide film 4 was then patterned as usual by, for example, photolithography and reactive ion etching to form a groove for interconnection and in a given area of the groove a connection hole reaching the lower interconnect 2. Then, Ta film with a thickness of 50 nm was formed by sputtering, a copper film with a thickness of about 50 nm was formed by sputtering, and then a copper film 6 with a thickness of about 2.0 μm was formed by plating.

The substrate thus prepared was subject to CMP using various polishing slurries shown in Table 1, and contamination in a polishing pad after polishing the copper film to about 2 μm was evaluated visually or on the basis of a polishing rate.

Citric acid, glutaric acid, glycine and benzotriazole (BTA) were obtained from Kanto Chemical Co. Silica was fumed silica Qs-9 from Tokuyama Sha and alumina was θ-alumina (AKP-G008) from Sumitomo Chemical Co., Ltd.

Table 1 shows the CMP results together with the compositions of the polishing slurries. In CMP using a polishing slurry comprising citric acid, adhesion of a polishing product to the polishing pad was little observed and a polishing rate was stable and constant until termination of polishing. On the other hand, in CMP using a polishing slurry comprising not citric acid but a carboxylic acid (glutaric acid) or an amino acid (glycine), a large amount of polishing product was adhered to the polishing pad at the end of polishing.

TABLE 1

| | Polishing | | | | pH | | Adhesion of a |
|---|---|---|---|---|---|---|---|
| | grains | Organic acid | H₂O₂ content | BTA content | regulator | Cu polishing | polishing product |
| No. | (content/wt %) | (content/wt %) | (wt %) | (wt %) | (pH) | rate (nm/min) | to a polishing pad |
| 1 | Alumina (8) | Glycine (0.125) | 1.7 | 0.005 | None (8.0) | 211.3 | Yes |
| 2 | Silica (5) | Glutaric acid (0.16) | 0.51 | 0.005 | KOH (4.3) | 181.6 | Yes |
| 3 | Silica (5) | Citric acid (0.254) | 0.51 | 0.005 | KOH (4.3) | 300.8 | No |
| 4 | Alumina (5) | Citric acid (1.50) | 2.38 | 0.005 | KOH (5.5) | 911.1 | No |
| | | Glutaric acid (0.16) | | | | | |
| | | Glycine (0.30) | | | | | |
| 5 | Alumina (5) | Citric acid (1.50) | 2.38 | 0.005 | KOH (5.5) | 808.8 | No |
| | | Glutaric acid (0.16) | | | | | |
| | | Glycine (0.30) | | | | | |
| 6 | Alumina (8) | Citric acid (0.75) | 2.38 | 0.010 | KOH (5.5) | 616.2 | No |
| | | Glutaric acid (0.16) | | | | | |
| | | Glycine (0.30) | | | | | |
| 7 | Alumina (8) | Citric acid (0.75) | 2.38 | 0.010 | NH₃ (5.5) | 623.2 | No |
| | | Glutaric acid (0.16) | | | | | |
| | | Glycine (0.30) | | | | | |
| 8 | Alumina (8) | Citric acid (0.75) | 2.38 | 0.005 | KOH (5.5) | 768.9 | No |
| | | Glutaric acid (0.16) | | | | | |
| | | Glycine (0.30) | | | | | |
| 9 | Alumina (8) | Citric acid (0.50) | 2.38 | 0.005 | KOH (5.5) | 619.9 | No |
| | | Glutaric acid (0.16) | | | | | |
| | | Glycine (0.30) | | | | | |
| 10 | Alumina (8) | Citric acid (0.50) | 2.38 | 0.005 | NH₃ (5.5) | 610.5 | No |
| | | Glutaric acid (0.16) | | | | | |
| | | Glycine (0.30) | | | | | |

What is claimed is:

1. A slurry used for chemical mechanical polishing of a substrate having a copper-containing film at the surface, which slurry contains an abrasive, an oxidizing agent, and an adhesion-inhibitor preventing adhesion of a polishing product to a polishing pad.

2. A slurry used for chemical mechanical polishing according to claim 1, wherein the adhesion-inhibitor is citric acid.

3. A slurry used for chemical mechanical polishing according to claim 1, which has a pH of 4 to 8.

4. A slurry used for chemical mechanical polishing according to claim 1, wherein the content of the adhesion-inhibitor is 0.01 to 5 wt %.

5. A slurry used for chemical mechanical polishing according to claim 1, which further contains a carboxylic acid other than citric acid or an amino acid.

6. A slurry used for chemical mechanical polishing according to claim 1, wherein the abrasive is silica grains or alumina grains and its content is 1 to wt %.

7. A slurry used for chemical mechanical polishing according to claim 1, wherein the oxidizing agent is hydrogen peroxide and its content is 0.01 to 15 wt %.

8. A slurry used for chemical mechanical polishing according to claim 1, which further contains an antioxidant.

9. A slurry used for chemical mechanical polishing according to claim 1, which further contains benztoriazole or its derivative.
